(19) United States
(12) Patent Application Publication
(10) Pub. No.: US 2006/0252394 A1
(43) Pub. Date: Nov. 9, 2006

(54) Switching circuit

(76) Inventors: Atsushi Suwa, Osaka (JP); Tadayoshi Nakatsuka, Osaka (JP)

Correspondence Address: PANASONIC PATENT CENTER;c/o MCDERMOTT WILL & EMERY LLP, 600 13TH STREET, NW, WASHINGTON, DC, 20005-3096, US

(21) Appl. No.: 11/405,447

(22) Filed: Apr. 18, 2006

(30) Foreign Application Priority Data
Apr. 21, 2005 (JP) 2005-124250

(51) Int. Cl. H04B 1/06

(52) U.S. Cl. 455/201

(57) ABSTRACT

A switching circuit includes: an antenna terminal; a plurality of input/output terminals each for receiving and outputting a signal; and a plurality of basic switching sections each connected between the antenna terminal and an associated one of the input/output terminals. Each of the basic switching sections includes: a through switch formed by FETs connected in series; and a shunt switch. The sources of the FETs forming the through switch and the shunt switch are connected to a first potential fixing terminal through resistors. The resistor connected to the source of the FET at the first stage in the shunt switch is connected to a potential fixing terminal through a diode connected in the forward direction.

### CROSS-REFERENCE TO RELATED APPLICATION

This application claims priority under 35 U.S.C. §119 on Patent Application No. 2005-124250 filed in Japan on Apr. 21, 2005, the entire contents of which are hereby incorporated by reference.

### BACKGROUND OF THE INVENTION

1. Field of the Invention

The present invention relates to switching circuits, and particularly relates to switching circuits using field-effect transistors for high-power RF signals.

2. Description of Related Art

With recent widespread use of communication equipment such as cellular phones, the need for switching circuits for switching radio-frequency (RF) signals has been increasing. In addition, with size reduction and cost reduction of communication equipment, small switching circuits formed at low cost are also needed. Antenna switches are required to efficiently switch high-power RF signals.

As such an antenna switch, a switching circuit formed by a combination of a plurality of basic switching circuits each including a plurality of field-effect transistors (TFTs) connected in series is known. For example, in Japanese Unexamined Patent Publication No. 2005-006072, a single pole double throw (SPDT) switching circuit formed by four basic switching circuits in each of which four FETs are connected in series is disclosed.

A conventional switching circuit includes: a through switch which is a basic switching circuit connected between an input/output terminal and an antenna terminal; and a shunt switch connected between the input/output terminal and the ground. When the shunt switch is turned ON with the through switch being in the OFF state, it is possible to increase isolation with the input/output terminal grounded.

However, in the conventional switching circuit, when a high-power RF signal is input to the input/output terminal in a state in which the through switch is ON and the shunt switch is OFF, a problem in which the shunt switch cannot be kept in the OFF state arises. If the shunt switch is not kept in the OFF state, the signal leaks to the ground through the shunt switch, resulting in occurrence of harmonic distortion.

To keep the shunt switch in the OFF state even with an input of a high-power signal, it is necessary to increase the number of stages of FETs forming the shunt switch or increase an “H”-level control voltage VH applied to a connection point between the FETs in the shunt switch. The increase in the number of stages of the shunt transistors leads to increases of the chip area and the cost. To increase the control voltage VH, additional components such as a booster circuit are needed, thus also leading to increases of the chip area and the cost.

### SUMMARY OF THE INVENTION

It is therefore an object of the present invention to provide a switching circuit in which harmonic distortion hardly occur at an input of a high-power signal without increase in packaging area and fabrication cost.

To achieve the object, according to the present invention, a potential applied between stages of shunt transistors is increased using a diode.

Specifically, a switching circuit according to the present invention includes: an antenna terminal; a plurality of input/output terminals each for receiving and outputting a signal; and a plurality of basic switching sections each connected between the antenna terminal and an associated one of the input/output terminals. Each of the basic switching sections includes: a through switch formed by a plurality of through transistors connected in series and having one terminal connected to one of the input/output terminals and another terminal connected to the antenna terminal; a shunt switch formed by a plurality of shunt transistors connected in series and having one terminal connected to said one of the input/output terminals and another terminal grounded through a shunt capacitor; a first potential fixing terminal connected to one of a source terminal and a drain terminal of each of the through transistors closer to the antenna terminal, the first potential fixing terminal being connected to the through transistors through respective first resistors; and a second potential fixing terminal closer to one of a source terminal and a drain terminal of each of the shunt transistors connected to a ground, the second potential fixing terminal being connected to the shunt transistors through respective second resistors. The first potential fixing terminal of one of the basic switching sections is connected to the second potential fixing terminal of another basic switching section. The second potential fixing terminal of said one of the basic switching sections is connected to the first potential fixing terminal of said another basic switching section. Said one of the basic switching sections includes a first diode connected between the second potential fixing terminal and one of the second resistors connected to a first-stage shunt transistor which is one of the shunt transistors closest to an associated one of the input/output terminals in a forward direction from the second resistor to the second potential fixing terminal.

In the switching circuit of the present invention, a potential applied to the source or drain of a first shunt transistor is increased by the forward voltage of a diode. Accordingly, the gate-drain voltage Vgd is also increased by the forward voltage of the diode, sot that it is possible to prevent a shunt transistor from turning ON even with an input of a high-power signal. As a result, a switching circuit in which even with an input of a high-power signal, leakage of the signal does not occur and harmonic distortion hardly occurs is obtained. In addition, it is unnecessary to substantially change the circuit configuration, so that the area occupied by the switching circuit and the fabrication cost hardly increase.

In the switching circuit of the present invention, the basic switching section including the first diode preferably further includes a first capacitor connected between an associated one of the input/output terminals and a gate terminal of the first-stage shunt transistor. With this configuration, the voltage between the stages in the shunt transistor and the through transistor is further increased.

In this case, the basic switching section including the first diode preferably further includes a first attenuation resistor connected in series with the first capacitor. With this configuration, it is possible to prevent damage to a circuit at a stage previous to the switching circuit caused by reflection of an input signal in a potential fixing resistor.

In the switching circuit of the present invention, the through transistors, the shunt transistors, the first diode and the first capacitor are preferably formed on a substrate made of gallium arsenide. This configuration allows a high-power signal to be input without substantial increase of the area occupied by the switching circuit.

In the switching circuit of the present invention, the basic switching section including the first diode preferably further includes a first attenuation resistor connected between an associated one of the input/output terminals and a gate terminal of the first-stage shunt transistor.

In the switching circuit of the present invention, the basic switching section including the first diode preferably further includes a first charge accumulating capacitor connected between the second potential fixing terminal and the ground. With this configuration, even when a voltage for controlling the switching circuit temporarily drops because of a trouble, it is possible to keep the shunt switch in the OFF state.

In the switching circuit of the present invention, the through transistors, the shunt transistors, the first diode and the first charge accumulating capacitor are preferably formed on a substrate made of gallium arsenide.

In the switching circuit of the present invention, at least one of the basic switching sections except for the basic switching section including the first diode preferably includes a second diode connected between the second potential fixing terminal and one of the second resistors connected to the first-stage shunt transistor in a forward direction from the second resistor to the second potential fixing terminal. This configuration allows a high-power signal to be input to another input terminal.

In the switching circuit of the present invention, the basic switching section including the second diode preferably further includes a second capacitor connected between an associated one of the input/output terminals and a gate terminal of the first shunt transistor.

In the switching circuit of the present invention, the basic switching section including the second diode preferably further includes a second attenuation resistor connected in series with the second capacitor.

In the switching circuit of the present invention, the basic switching section including the second diode preferably further includes a second charge accumulating capacitor connected between the second potential fixing terminal and the ground.

In the switching circuit of the present invention, the basic switching section including the second diode preferably further includes a second attenuation resistor connected between an associated one of the input/output terminals and a gate terminal of the first-stage shunt transistor.

In the switching circuit of the present invention, the basic switching section including the first diode preferably further includes a third diode connected between the first potential fixing terminal and one of the first resistors connected to a first-stage through transistor which is one of the through transistors closest to an associated one of the input/output terminals in a forward direction from the first resistor to the first potential fixing terminal. With this configuration, it is possible to keep the through switch in the OFF state even with an input of high power.

In the switching circuit of the present invention, the basic switching section including the third diode preferably further includes a third capacitor connected between an associated one of the input/output terminals and a gate terminal of the first-stage through transistor.

In the switching circuit of the present invention, the basic switching section including the third diode preferably further includes a third attenuation resistor connected in series with the third capacitor.

In the switching circuit of the present invention, the basic switching section including the third diode preferably further includes a third attenuation resistor connected between an associated one of the input/output terminals and a gate terminal of the first-stage through transistor.

In the switching circuit of the present invention, at least one of the basic switching sections except for the basic switching section including the first diode preferably further includes a fourth diode connected between the first potential fixing terminal and one of the first resistors connected to the first-stage through transistor in a forward direction from the first resistor to the first potential fixing terminal.

In the switching circuit of the present invention, the basic switching section including the fourth diode preferably further includes a fourth capacitor connected between an associated one of the input/output terminals and a gate terminal of the first-stage through transistor.

In the switching circuit of the present invention, the basic switching section including the fourth diode preferably further includes a fourth attenuation resistor connected in series with the fourth capacitor.

In the switching circuit of the present invention, the basic switching section including the fourth diode preferably further includes a fourth attenuation resistor connected between an associated one of the input/output terminals and a gate terminal of the first-stage through transistor.

A composite RF component according to the present invention uses the switching circuit of the present invention.

A mobile communication system according to the present invention uses the switching circuit of the present invention.

A mobile communication system according to the present invention uses the composite RF component of the present invention.

### BRIEF DESCRIPTION OF THE DRAWINGS

FIG. 1 is a circuit diagram illustrating a switching circuit according to a first embodiment of the present invention.

FIG. 2 is a circuit diagram illustrating a shunt switch included in the switching circuit of the first embodiment in an enlarged manner.

FIG. 3 is a circuit diagram illustrating the shunt switch included in the switching circuit of the first embodiment in an enlarged manner.

FIG. 4 is graphs showing voltages applied to shunt transistors in the switching circuit of the first embodiment.

FIG. 5 is a circuit diagram showing voltages applied to a shunt transistor in the switching circuit of the first embodiment.

FIG. 6 is a circuit diagram illustrating a switching circuit according to a second embodiment of the present invention.

FIG. 7 is a circuit diagram illustrating a switching circuit according to a third embodiment of the present invention.

FIG. 8 is a circuit diagram illustrating a switching circuit according to a fourth embodiment of the present invention.

FIG. 9 is a circuit diagram illustrating a switching circuit according to a fifth embodiment of the present invention.

FIG. 10 is a circuit diagram illustrating a switching circuit according to a sixth embodiment of the present invention.

### DETAILED DESCRIPTION OF THE INVENTION

### Embodiment 1

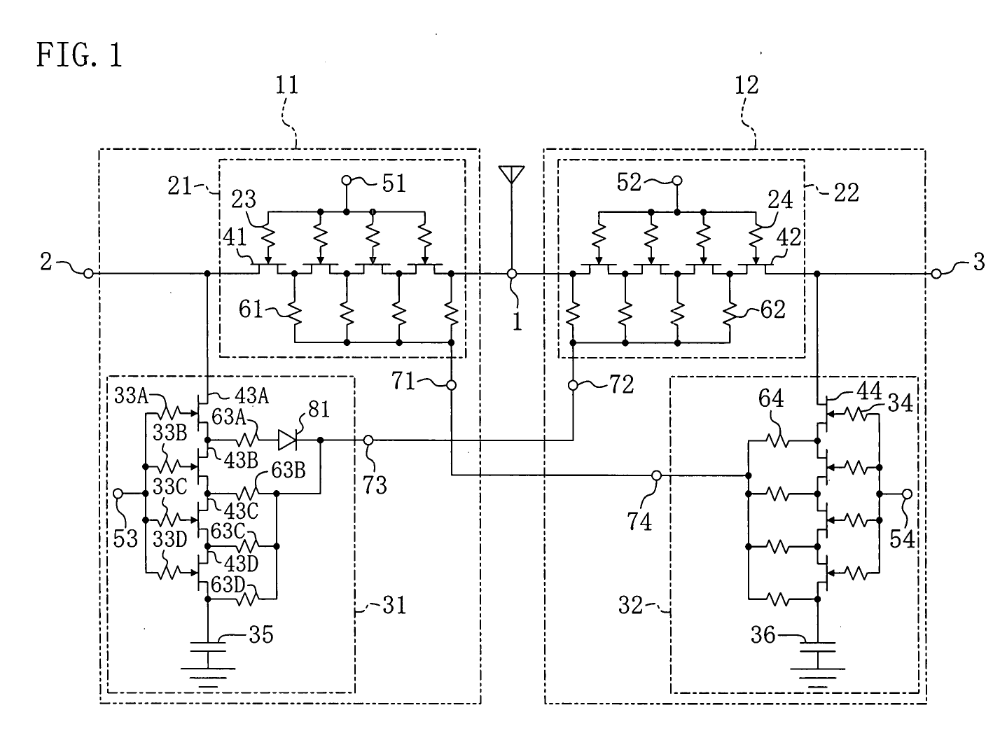

A switching circuit according to a first embodiment of the present invention will be described with reference to the drawings. FIG. 1 illustrates a circuit configuration of the switching circuit of the first embodiment.

As illustrated in FIG. 1, in the switching circuit of this embodiment, a first input/output terminal 2 and a second input/output terminal 3 are provided with an antenna terminal 1 sandwiched therebetween, a first basic switching section 11 is provided between the antenna terminal 1 and the first input/output terminal 2, and a second basic switching section 12 is provided between the antenna terminal 1 and the second input/output terminal 3.

The first basic switching section 11 includes: a first through switch 21 having one terminal connected to the antenna terminal 1 and the other terminal connected to the first input/output terminal 2; and a first shunt switch 31 having one terminal connected to the first input/output terminal 2 and the other terminal grounded through a first shunt capacitor 35. In the same manner, the second basic switching section 12 includes: a second through switch 22 having one terminal connected to the antenna terminal 1 and the other terminal connected to the second input/output terminal 3; and a second shunt switch 32 having one terminal connected to the second input/output terminal 3 and the other terminal grounded through a second shunt capacitor 36.

The first through switch 21 is formed by four through field-effect transistors (FETs) 41 respectively provided in four stages and connected in series. The gates of the four through FETs 41 are connected to a first control terminal 51 through respective gate resistors 23. The gates of four through FETs 42 forming the second through switch 22 are connected to a second control terminal 52 through respective gate resistors 24.

The first shunt switch 31 is formed by four shunt FETs 43 respectively provided in four stages and connected in series. The gates of the four shunt FETs 43 forming the first shunt switch 31 are connected to a third control terminal 53 through respective gate resistors 33. The gates of four shunt FETs 44 forming the second through switch 32 are connected to a fourth control terminal 54 through respective gate resistors 34.

The sources of the four through FETs 41 forming the first through switch 21 are connected to a first potential fixing terminal 71 through respective potential fixing resistors 61. The sources of the four shunt FETs 44 forming the second shunt switch 32 are connected to a fourth potential fixing terminal 74 through respective potential fixing resistors 64. The first potential fixing terminal 71 and the fourth potential fixing terminal 74 are electrically connected to each other.

The sources of the four through FETs 42 forming the second through switch 22 are connected to a second potential fixing terminal 72 through respective potential fixing resistors 62. Out of the four shunt FETs 43 forming the first shunt switch 31, the sources of shunt FETs 43B through 43D except for a shunt FET 43A closest to the first input/output terminal 2 are connected to a third potential fixing terminal 73 through respective potential fixing resistors 63 (i.e., 63B through 63D). The source of the shunt FET 43A is connected to a potential fixing resistor 63A and the third potential fixing terminal 73 through a diode 81. The diode 81 is oriented in the forward direction from the potential fixing resistor 63A to the third potential fixing terminal 73. The second potential fixing terminal 72 and the third potential fixing terminal 73 are electrically connected to each other.

Now, it will be described how occurrence of harmonic distortion is suppressed in the switching circuit of the first embodiment even when a high-power signal is input.

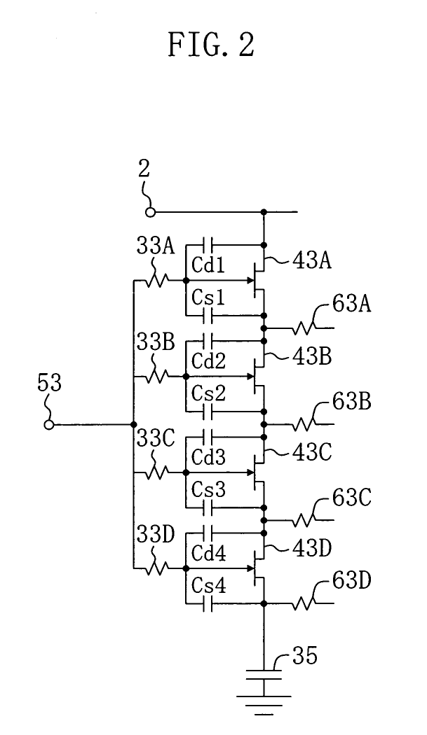

FIG. 2 illustrates a circuit configuration of the first shunt switch 31 illustrated in FIG. 1, including gate-drain capacitors Cd and gate-source capacitors Cs.

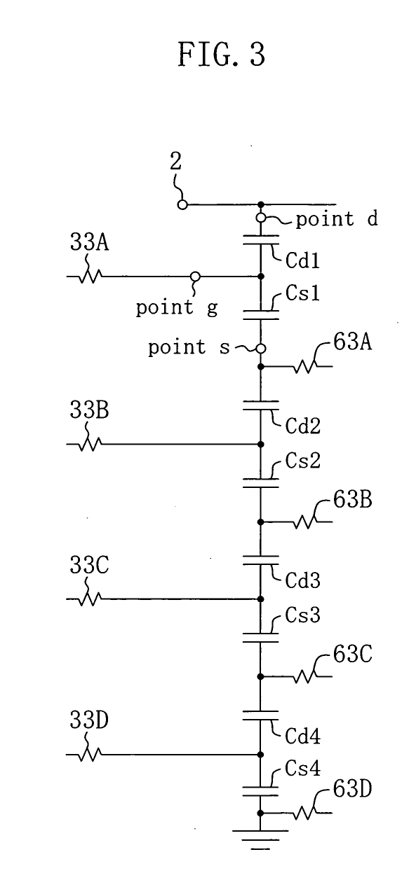

In a state in which a high (“H”)-level control voltage VH is applied to the first control terminal 51, a low (“L”)-level control voltage VL is applied to the third control terminal 53 and a path between the antenna terminal 1 and the first input/output terminal 2 is ON, the shunt FETs 43A through 43D are OFF. Accordingly, it can be assumed that the gate-drain capacitors Cd and the gate-source capacitors Cs are connected in series. That is, this state is equivalent to a state in which eight capacitors Cd1 through Cs2 and the first shunt capacitor 35 are connected in series as illustrated in FIG. 3. It should be noted that the first shunt capacitor 35 is omitted because the first shunt capacitor 35 is a capacitor having a sufficiently large capacitance as compared to the gate-drain capacitors Cd and the gate-source capacitors Cs and has an impedance at a negligible level.

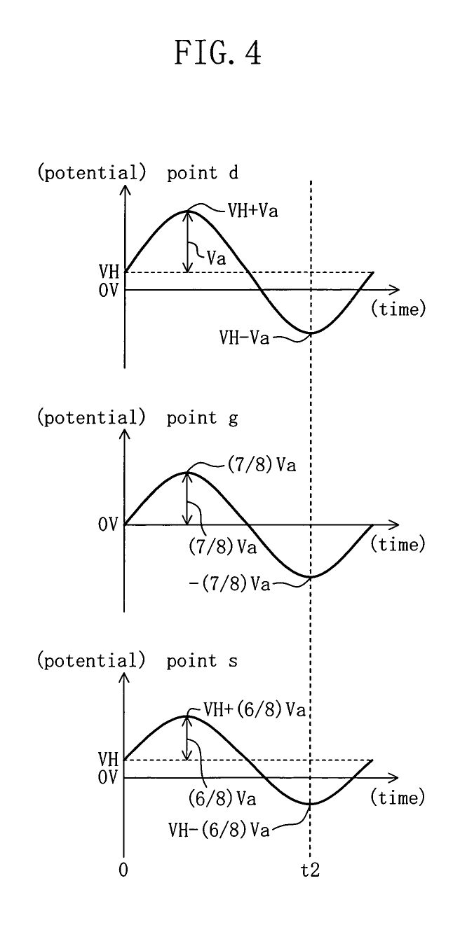

Suppose the amplitude of a signal input to the first input/output terminal 2 is Va in FIG. 3, a voltage with one-eighth of the amplitude Va is applied between the electrodes of every adjacent two of the capacitors Cd1 through Cs4. At this time, voltages respectively applied to the drain, gate and source terminals (points d, g and s, respectively, in FIG. 3) of the shunt FET 43A are shown in FIG. 4. The potential at the point d is substantially equal to the “H”-level control voltage VH because of an internal self-bias in the FET, so that a voltage with an amplitude of Va with respect to VH is applied to the point d. A voltage with seven-eights of the amplitude Va with respect to the “L”-level control voltage VL (i.e., 0V) applied to the third control terminal 53 is applied to the point g. The potential VH at the point d is biased through the potential fixing resistors 63, so that a voltage with six-eights of the amplitude Va with respect to VH is applied to the point s.

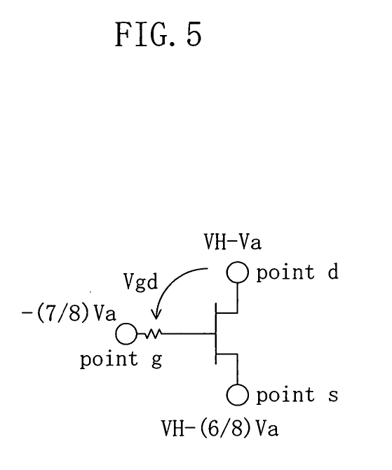

Accordingly, the potentials at the respective terminals of the shunt FET 43A at timing t2 in FIG. 4 change to those shown in FIG. 5. In this state, to keep the shunt FET 43A in the OFF state, the gate-drain voltage Vgd needs to be lower than the threshold voltage Vth of the shunt FET 43A. If n FETs are connected in series, the gate-drain voltage Vgd is obtained by Equation 1:
Vgd=(½n)Va−VH (1)

For example, if the threshold voltage Vth, the “H”-level control voltage VH and the amplitude Va of an input signal are −1.0V, 5V and 20V, respectively, the gate-drain voltage Vgd is −2.5V according to Equation 1 and is lower than the threshold voltage Vth, so that the shunt FET 43A is kept in the OFF state.

However, if a higher-power signal is input from the first input/output terminal 2, e.g., if the amplitude Va is 40V, the gate-drain voltage Vgd changes to 0V and the shunt FET 43A disadvantageously turns ON. If the shunt FET 43A turns ON, the input RF signal leaks to the ground through the shunt FET 43A, resulting in that the waveform becomes distorted and harmonic distortion occurs.

In the switching circuit of this embodiment, the potential fixing resistor 63A is connected to the anode terminal of the diode 81. A signal input to the first input/output terminal 2 passes through the gate-drain capacitor Cd1 and the gate-source capacitor Cs1 in the shunt FET 43A and the potential fixing resistor 63A to reach the anode terminal of the diode 81. When the potential difference between the anode terminal and the cathode terminal exceeds the forward voltage of the diode 81 because of the amplitude of the RF signal, charge starts flowing from the anode terminal to the cathode terminal, so that the potential at the cathode terminal rises by the forward voltage Vα of the diode 81. Accordingly, the gate-drain voltage Vgd is expressed by Equation 2, and is lower, by the forward voltage Vα, than that in a case where the diode 81 is not provided.
Vgd=(½n)Va−(VH+Vα) (2)

As a result, even when a high-power signal is input to the first input/output terminal 2, leakage of the signal is less likely to occur, and thus it is possible to suppress occurrence of harmonic distortion.

Components of a switching circuit are generally formed on a substrate made of gallium arsenide (GaAs) as one unit. A diode occupies a very small area of the GaAs substrate, and the area occupied by the switching circuits is hardly increased by the addition of a diode. In addition, the circuit configuration thereof is very simple, so that the fabrication cost is hardly increased by the addition of the diode. Accordingly, as compared to a case where the number of stages of shunt FETs is increased or a case where a booster circuit for increasing the “H”-level control voltage VH is provided, a switching circuit for achieving a small chip area and allowing an input of high power is implemented with almost no increase of fabrication cost.

### Embodiment 2

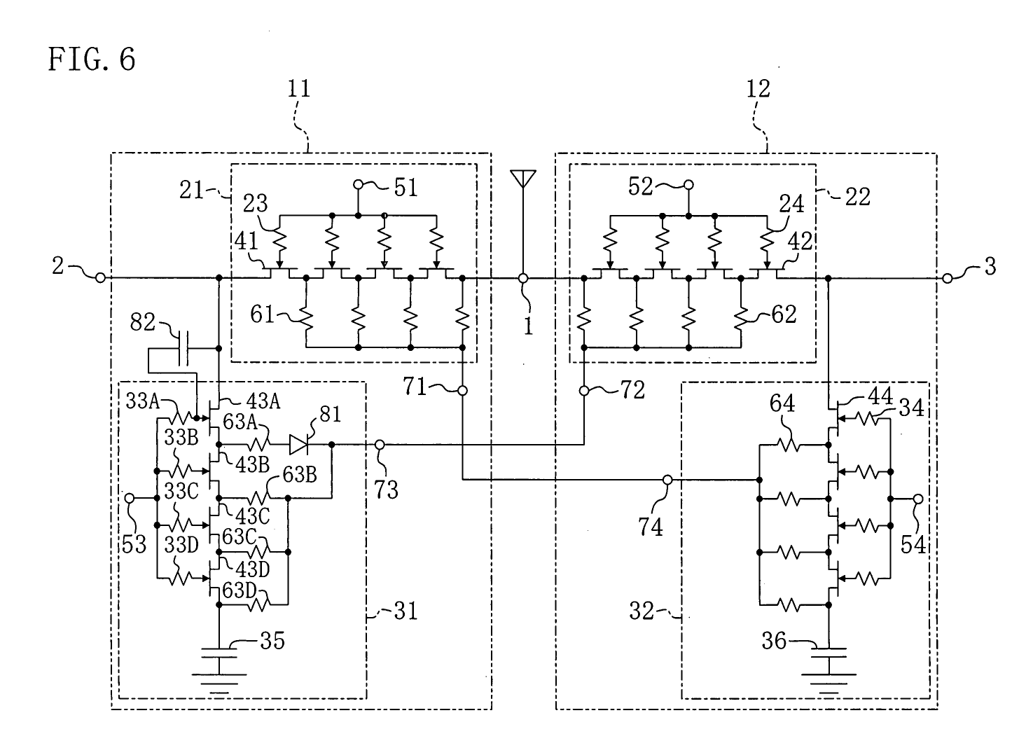

Hereinafter, a switching circuit according to a second embodiment of the present invention will be described with reference to the drawings. FIG. 6 illustrates a circuit configuration of the switching circuit of the second embodiment. In FIG. 6, components also shown in FIG. 1 are denoted by the same reference numerals, and description thereof will be omitted.

As illustrated in FIG. 6, in the switching circuit of this embodiment, a capacitor 82 is connected between a first input/output terminal 2 and the gate of a shunt FET 43A.

In the first embodiment, an RF signal input to the first input/output terminal 2 passes through the gate-drain capacitor Cd1, the gate-source capacitor Cs1 and the potential fixing resistor 63A to reach the anode terminal of the diode 81. However, the capacitances of the gate-drain capacitor Cd1 and the gate-source capacitor Cs1 are very small and the impedances thereof are very high. Accordingly, a very small portion of signals input to the first input/output terminal 2 reaches the anode terminal of the diode 81.

On the other hand, in the switching circuit of the second embodiment, the capacitor 82 is connected between the first input/output terminal 2 and the gate of the shunt FET 43A, so that the capacitance between the drain and gate of the shunt FET 43A increases and the impedance decreases. This allows a direct-current (DC) potential to be obtained by utilizing an RF signal with a higher amplitude input to the first input/output terminal 2. Accordingly, the potential at the source of the shunt FET 43A is fixed at a higher voltage. In addition, the potentials at the sources of respective shunt FETs 43B through 43D connected in parallel and the potentials at the sources of respective through FETs 42 are also high. As a result, even when a high-power signal is input to the first input/output terminal 2, a first shunt switch and a second through switch are kept in the OFF states, thus enabling suppression of harmonic distortion.

### Embodiment 3

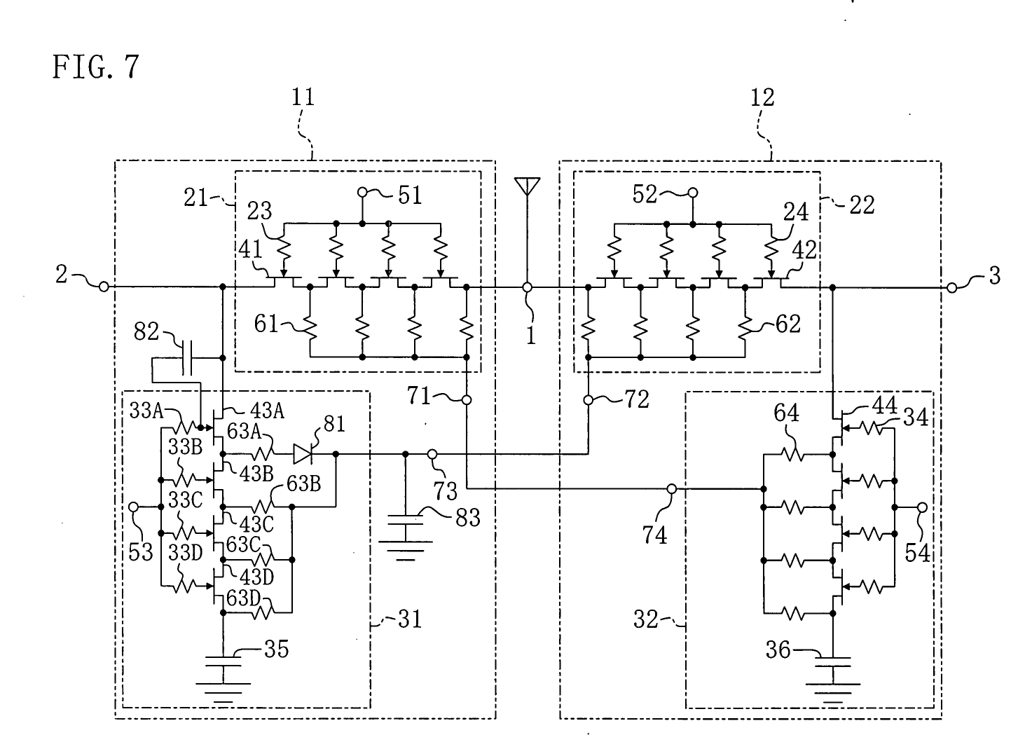

Hereinafter, a switching circuit according to a third embodiment of the present invention will be described with reference to the drawings. FIG. 7 illustrates a circuit configuration of the switching circuit of the third embodiment. In FIG. 7, components also shown in FIG. 6 are denoted by the same reference numerals, and description thereof will be omitted.

In the switching circuit of this embodiment as illustrated in FIG. 7, a charge accumulating capacitor 83 is connected between a third control terminal 53 and the ground.

In the switching circuits of the first and second embodiments, when an “H”-level control voltage VH decreases because of a failure or a trouble in a control circuit, a voltage applied to the source of the shunt FET 43A also decreases. Accordingly, the gate-drain voltage Vgd of the shunt FET 43A increases. As a result, even when the amplitude of an RF signal input to the first input/output terminal 2 is low, the shunt FET 43A is turned ON and harmonic distortion occurs.

On the other hand, in the switching circuit of this embodiment, the charge accumulating capacitor 83 for accumulating charge is connected between a third potential fixing terminal 73 and the ground. Charge accumulated in a capacitor in a circuit is generally discharged in a period of time determined by a time constant τ which is the product of a capacitance and a resistance of the circuit. Accordingly, an abrupt drop of a voltage applied to the source of a shunt FET 43A is prevented.

This enables implementation of a switching circuit in which the shunt FET 43A is kept in the OFF state and harmonic distortion is less likely to occur even when an “H”-level control voltage VH temporarily decreases because of a trouble in a control circuit.

In this embodiment, the charge accumulating capacitor 83 is added to the switching circuit of the second embodiment. Alternatively, a charge accumulating capacitor may be added to the switching circuit of the first embodiment.

### Embodiment 4

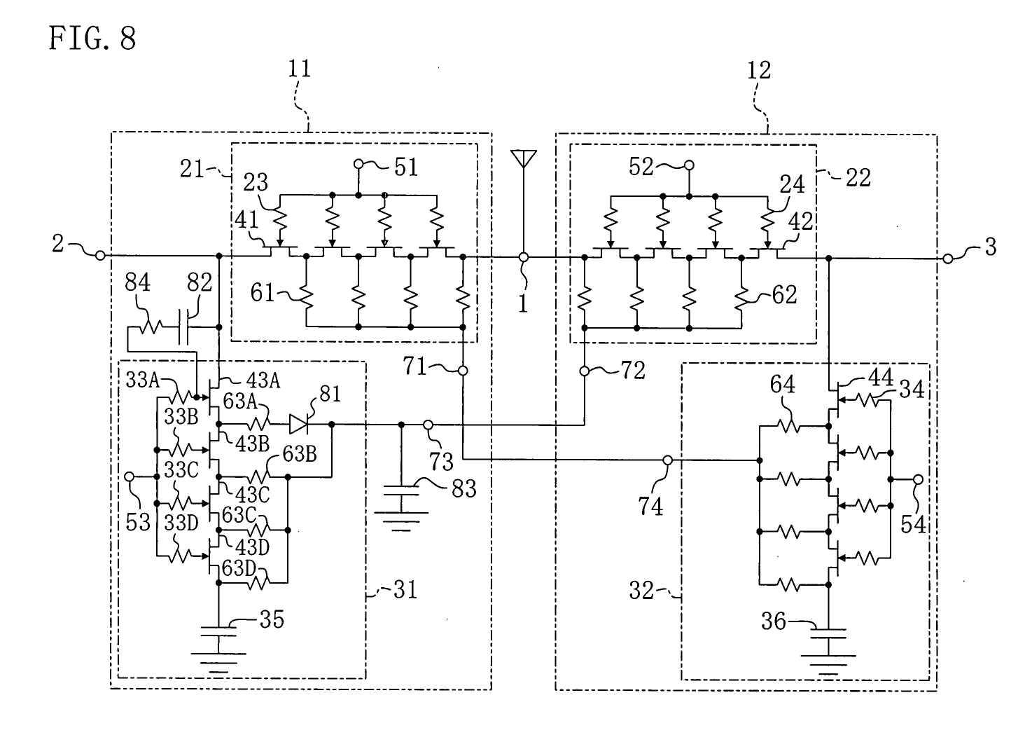

Hereinafter, a switching circuit according to a fourth embodiment of the present invention will be described with reference to the drawings. FIG. 8 illustrates a circuit configuration of the switching circuit of the fourth embodiment. In FIG. 8, components also shown in FIG. 7 are denoted by the same reference numerals, and description thereof will be omitted.

As illustrated in FIG. 8, in the switching circuit of this embodiment, a resistor is inserted between a capacitor 82 and the gate of a shunt FET 43A.

An RF signal which has passed through the capacitor 82 and the shunt FET 43A reaches a potential fixing resistor 63A. The potential fixing resistor 63A has a resistance of several kΩ to several hundreds kΩ and has a high impedance. Accordingly, the signal is reflected in the potential fixing resistor 63A. When the reflected signal is fed back from an input/output terminal to an amplifier, for example, at a stage previous to the switching circuit, the amplifier might be broken or other problems arise.

In the switching circuit of the fourth embodiment, an attenuation resistor 84 is inserted between the capacitor 82 and the gate terminal of the shunt FET 43A. Accordingly, the signal reflected in the potential fixing resistor 63A is attenuated by the attenuation resistor 84. As a result, even when the reflected signal is fed back to the amplifier provided at the stage previous to the switching circuit, damage to the amplifier is prevented.

In this embodiment, both the attenuation resistor 84 and the capacitor 82 are provided. Alternatively, only attenuation resistor 84 may be provided. The positions of the attenuation resistor 84 and the capacitor 82 may be replaced with each other.

### Embodiment 5

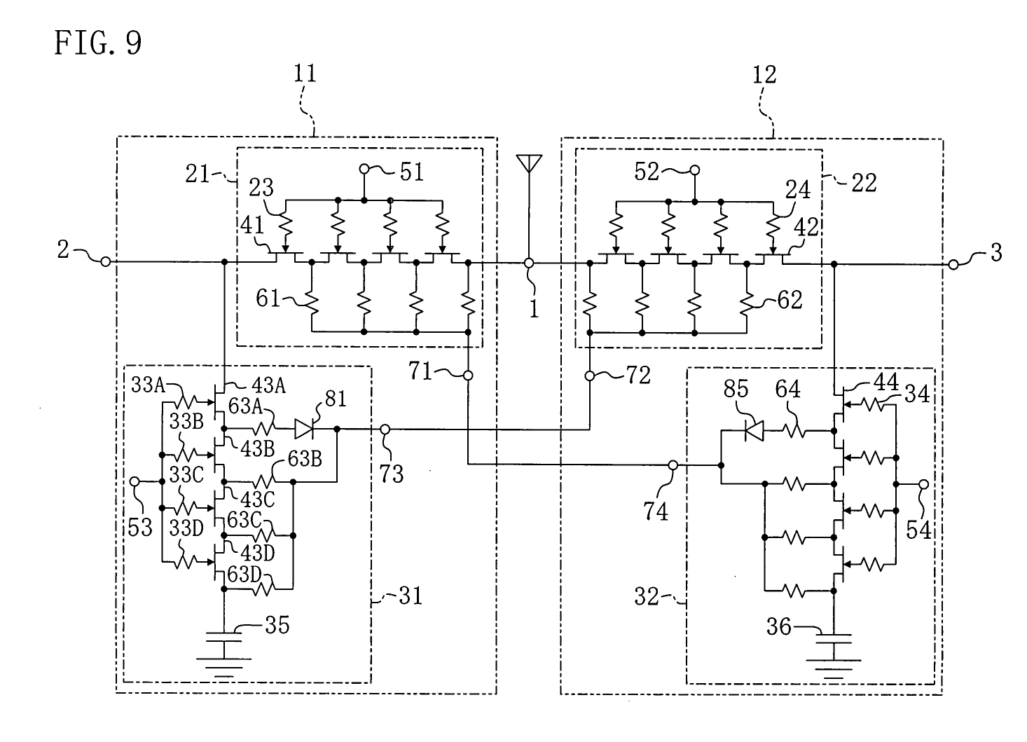

Hereinafter, a switching circuit according to a fifth embodiment of the present invention will be described with reference to the drawings. FIG. 9 illustrates a circuit configuration of the switching circuit of the fifth embodiment. In FIG. 9, components also shown in FIG. 7 are denoted by the same reference numerals, and description thereof will be omitted.

As illustrated in FIG. 9, in the switching circuit of this embodiment, a potential fixing resistors 64 and a diode 85 are connected in series with the source of a shunt FET 44 at the first stage in a second shunt switch 32, as in a first shunt switch 31. This enables a high-power signal to be also input to a second input/output terminal 3.

As in the second through fourth embodiments, in addition to the diodes 81 and 85, a capacitor, a charge accumulating capacitor and/or an attenuation resistor may be provided when necessary.

### Embodiment 6

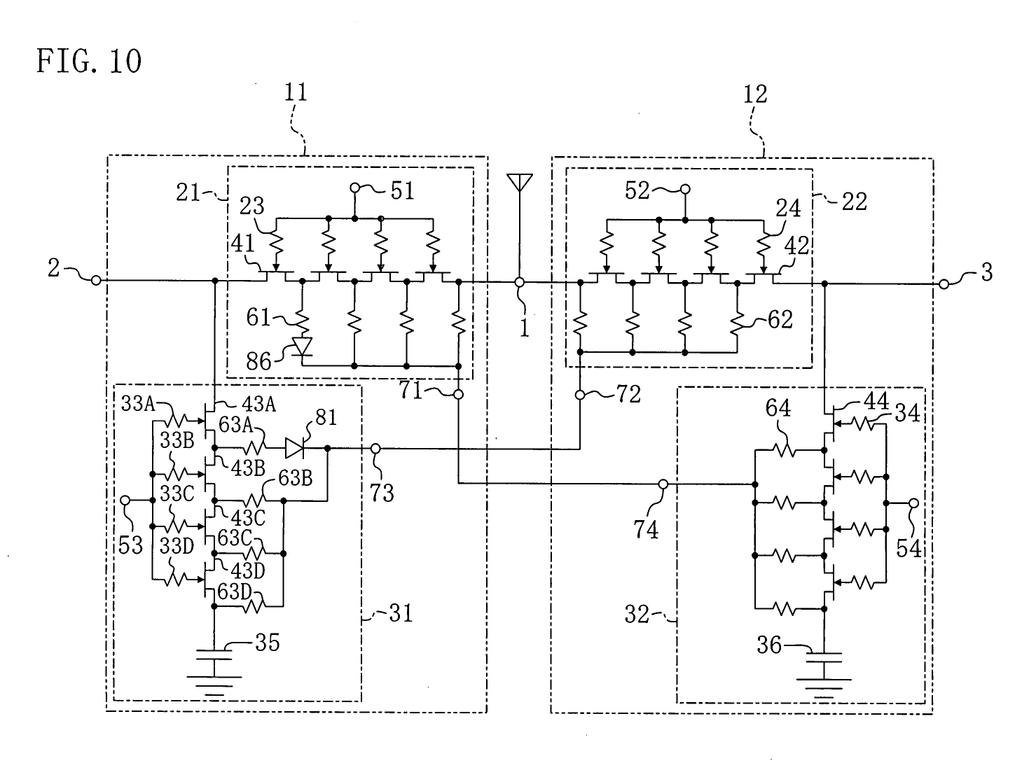

Hereinafter, a switching circuit according to a sixth embodiment of the present invention will be described with reference to the drawings. FIG. 10 illustrates a circuit configuration of the switching circuit of the sixth embodiment. In FIG. 10, components also shown in FIG. 7 are denoted by the same reference numerals, and description thereof will be omitted.

As illustrated in FIG. 10, in the switching circuit of this embodiment, a potential fixing resistors 61 and a diode 86 are connected in series with the source of a through FET 41 at the first stage in a first through switch 21. This prevents leakage of a signal from the first through switch 21 when the first through switch 21 is in the OFF state.

As in the second through fourth embodiments, in addition to the diodes 81 and 86, a capacitor, a charge accumulating capacitor and/or an attenuation resistor may be provided when necessary.

As in the fifth embodiment, the second basic switching section 12 may have a configuration similar to that of a first basic switching section 11. This enables a high-power signal to be also input to a second input/output terminal 3.

In the foregoing embodiments, description is given on an SPDT switch as an example. Alternatively, the number of basic switching sections connected to the antenna terminal may be increased to an arbitrary number. In this case, the potential fixing terminal of a through switch connected to an input/output terminal to which the highest-power signal is input is preferably connected to the potential fixing terminal of another shunt switch, and the potential fixing terminal of a shunt switch connected to the input/output terminal to which the highest-power signal is input is preferably connected to the potential fixing terminal of another through switch.

If a plurality of switching circuits having an identical configuration are prepared and the respective control terminals thereof are connected in parallel, an arbitrary multiple pole multiple throw switch is implemented.

In the foregoing embodiments, each of the through switches and the shunt switches is formed by four FETs, as an example. Alternatively, the number of FETs forming each of the through switches and the shunt switches may be arbitrarily changed. The number of FETs forming each of the through switches and the number of FETs forming each of the shunt switches may differ from each other.

As described above, a switching circuit according to the present invention has an advantage in which harmonic distortion hardly occurs even with an input of a high-power signal without increase in packaging area and fabrication cost. The switching circuit is useful as, for example, a switching circuit using field-effect transistors for high-power RF signals.

What is claimed is:

1. A switching circuit, comprising:
an antenna terminal;
a plurality of input/output terminals each for receiving and outputting a signal; and
a plurality of basic switching sections each connected between the antenna terminal and an associated one of the input/output terminals,
wherein each of the basic switching sections includes
a through switch formed by a plurality of through transistors connected in series and having one terminal connected to one of the input/output terminals and another terminal connected to the antenna terminal,
a shunt switch formed by a plurality of shunt transistors connected in series and having one terminal connected to said one of the input/output terminals and another terminal grounded through a shunt capacitor,
a first potential fixing terminal connected to one of a source terminal and a drain terminal of each of the through transistors closer to the antenna terminal, the first potential fixing terminal being connected to the through transistors through respective first resistors, and
a second potential fixing terminal connected to one of a source terminal and a drain terminal of each of the shunt transistors closer to a ground, the second potential fixing terminal being connected to the shunt transistors through respective second resistors,
wherein the first potential fixing terminal of one of the basic switching sections is connected to the second potential fixing terminal of another basic switching section,
the second potential fixing terminal of said one of the basic switching sections is connected to the first potential fixing terminal of said another basic switching section, and
said one of the basic switching sections includes a first diode connected between the second potential fixing terminal and one of the second resistors connected to a first-stage shunt transistor which is one of the shunt transistors closest to an associated one of the input/output terminals in a forward direction from the second resistor to the second potential fixing terminal.

2. The switching circuit of claim 1, wherein the basic switching section including the first diode further includes a first capacitor connected between an associated one of the input/output terminals and a gate terminal of the first-stage shunt transistor.

3. The switching circuit of claim 2, wherein the basic switching section including the first diode further includes a first attenuation resistor connected in series with the first capacitor.

4. The switching circuit of claim 2, wherein the through transistors, the shunt transistors, the first diode and the first capacitor are formed on a substrate made of gallium arsenide.

5. The switching circuit of claim 1, wherein the basic switching section including the first diode further includes a first attenuation resistor connected between an associated one of the input/output terminals and a gate terminal of the first-stage shunt transistor.

6. The switching circuit of claim 1, wherein the basic switching section including the first diode further includes a first charge accumulating capacitor connected between the second potential fixing terminal and the ground.

7. The switching circuit of claim 6, wherein the through transistors, the shunt transistors, the first diode and the first charge accumulating capacitor are formed on a substrate made of gallium arsenide.

8. The switching circuit of claim 1, wherein at least one of the basic switching sections except for the basic switching section including the first diode includes a second diode connected between the second potential fixing terminal and one of the second resistors connected to the first-stage shunt transistor in a forward direction from the second resistor to the second potential fixing terminal.

9. The switching circuit of claim 8, wherein the basic switching section including the second diode further includes a second capacitor connected between an associated one of the input/output terminals and a gate terminal of the first shunt transistor.

10. The switching circuit of claim 9, wherein the basic switching section including the second diode further includes a second attenuation resistor connected in series with the second capacitor.

11. The switching circuit of claim 8, wherein the basic switching section including the second diode further includes a second attenuation resistor connected between an associated one of the input/output terminals and a gate terminal of the first-stage shunt transistor.

12. The switching circuit of claim 8, wherein the basic switching section including the second diode further includes a second charge accumulating capacitor connected between the second potential fixing terminal and the ground.

13. The switching circuit of claim 1, wherein the basic switching section including the first diode further includes a third diode connected between the first potential fixing terminal and one of the first resistors connected to a first-stage through transistor which is one of the through transistors closest to an associated one of the input/output terminals in a forward direction from the first resistor to the first potential fixing terminal.

14. The switching circuit of claim 13, wherein the basic switching section including the third diode further includes a third capacitor connected between an associated one of the input/output terminals and a gate terminal of the first-stage through transistor.

15. The switching circuit of claim 14, wherein the basic switching section including the third diode further includes a third attenuation resistor connected in series with the third capacitor.

16. The switching circuit of claim 13, wherein the basic switching section including the third diode further includes a third attenuation resistor connected between an associated one of the input/output terminals and a gate terminal of the first-stage through transistor.

17. The switching circuit of claim 1, wherein at least one of the basic switching sections except for the basic switching section including the first diode further includes a fourth diode connected between the first potential fixing terminal and one of the first resistors connected to the first-stage through transistor in a forward direction from the first resistor to the first potential fixing terminal.

18. The switching circuit of claim 17, wherein the basic switching section including the fourth diode further includes a fourth capacitor connected between an associated one of the input/output terminals and a gate terminal of the first-stage through transistor.

19. The switching circuit of claim 18, wherein the basic switching section including the fourth diode further includes a fourth attenuation resistor connected in series with the fourth capacitor.

20. The switching circuit of claim 17, wherein the basic switching section including the fourth diode further includes a fourth attenuation resistor connected between an associated one of the input/output terminals and a gate terminal of the first-stage through transistor.

21. A composite RF component, comprising a switching circuit including an antenna terminal, a plurality of input/output terminals each for receiving and outputting a signal and a plurality of basic switching sections each connected between the antenna terminal and an associated one of the input/output terminals,
wherein each of the basic switching sections includes:
a through switch formed by a plurality of through transistors connected in series and having one terminal connected to one of the input/output terminals and another terminal connected to the antenna terminal;
a shunt switch formed by a plurality of shunt transistors connected in series and having one terminal connected to said one of the input/output terminals and another terminal grounded through a shunt capacitor;
a first potential fixing terminal connected to one of a source terminal and a drain terminal of each of the through transistors closer to the antenna terminal, and the first potential fixing terminal is connected to the through transistors through respective first resistors; and
a second potential fixing terminal connected to one of a source terminal and a drain terminal of each of the shunt transistors closer to a ground, and the second potential fixing terminal is connected to the shunt transistors through respective second resistors,
wherein the first potential fixing terminal of one of the basic switching sections is connected to the second potential fixing terminal of another basic switching section,
the second potential fixing terminal of said one of the basic switching sections is connected to the first potential fixing terminal of said another basic switching section, and
said one of the basic switching sections includes a first diode connected between the second potential fixing terminal and one of the second resistors connected to a first-stage shunt transistor which is one of the shunt transistors closest to an associated one of the input/output terminals in a forward direction from the second resistor to the second potential fixing terminal.

22. A mobile communication system, comprising a switching circuit including an antenna terminal, a plurality of input/output terminals each for receiving and outputting a signal and a plurality of basic switching sections each connected between the antenna terminal and an associated one of the input/output terminals,
wherein each of the basic switching sections includes:
a through switch formed by a plurality of through transistors connected in series and having one terminal connected to one of the input/output terminals and another terminal connected to the antenna terminal;
a shunt switch formed by a plurality of shunt transistors connected in series and having one terminal connected to said one of the input/output terminals and another terminal grounded through a shunt capacitor;
a first potential fixing terminal connected to one of a source terminal and a drain terminal of each of the through transistors closer to the antenna terminal, and the first potential fixing terminal is connected to the through transistors through respective first resistors; and
a second potential fixing terminal connected to one of a source terminal and a drain terminal of each of the shunt transistors closer to a ground, and the second potential fixing terminal is connected to the shunt transistors through respective second resistors,
wherein the first potential fixing terminal of one of the basic switching sections is connected to the second potential fixing terminal of another basic switching section,
the second potential fixing terminal of said one of the basic switching sections is connected to the first potential fixing terminal of said another basic switching section, and said one of the basic switching sections includes a first diode connected between the second potential fixing terminal and one of the second resistors connected to a first-stage shunt transistor which is one of the shunt transistors closest to an associated one of the input/output terminals in a forward direction from the second resistor to the second potential fixing terminal.

23. A mobile communication system, comprising a composite RF component including a switching circuit including an antenna terminal, a plurality of input/output terminals each for receiving and outputting a signal and a plurality of basic switching sections each connected between the antenna terminal and an associated one of the input/output terminals,
wherein each of the basic switching sections includes:
a through switch formed by a plurality of through transistors connected in series and having one terminal connected to one of the input/output terminals and another terminal connected to the antenna terminal;
a shunt switch formed by a plurality of shunt transistors connected in series and having one terminal connected to said one of the input/output terminals and another terminal grounded through a shunt capacitor;
a first potential fixing terminal connected to one of a source terminal and a drain terminal of each of the through transistors closer to the antenna terminal, and the first potential fixing terminal is connected to the through transistors through respective first resistors; and
a second potential fixing terminal connected to one of a source terminal and a drain terminal of each of the shunt transistors closer to a ground, and the second potential fixing terminal is connected to the shunt transistors through respective second resistors,
wherein the first potential fixing terminal of one of the basic switching sections is connected to the second potential fixing terminal of another basic switching section,
the second potential fixing terminal of said one of the basic switching sections is connected to the first potential fixing terminal of said another basic switching section, and
said one of the basic switching sections includes a first diode connected between the second potential fixing terminal and one of the second resistors connected to a first-stage shunt transistor which is one of the shunt transistors closest to an associated one of the input/output terminals in a forward direction from the second resistor to the second potential fixing terminal.
